(19) United States
(12) Patent Application Publication
(10) Pub. No.: US 2015/0016852 A1
(43) Pub. Date: Jan. 15, 2015

(54) FIXING DEVICE, AND IMAGE FORMING APPARATUS

(71) Applicant: FUJI XEROX CO., LTD., Tokyo (JP)

(72) Inventors: Nobuhiro KATSUTA, Kanagawa (JP); Yutaka NOGAMI, Kanagawa (JP); Satoshi TATSUURA, Kanagawa (JP); Kazunari KOMATSUZAKI, Kanagawa (JP)

(73) Assignee: FUJI XEROX CO., LTD., Tokyo (JP)

(21) Appl. No.: 14/184,174

(22) Filed: Feb. 19, 2014

(30) Foreign Application Priority Data
Jul. 9, 2013 (JP) 2013-143884

(51) Int. Cl. G03G 15/20

(52) U.S. Cl. CPC G03G 15/2064
USPC 399/320; 399/328

(57) ABSTRACT

Provided is a fixing device, including a fixing unit that fixes a toner image developed by a developer including toner and a carrier liquid to a recording medium, and a preprocessing unit that includes a metallic rotating body that is placed on the toner image side of the recording medium and rotates, a pressure member that includes an elastic layer and pressurizes the recording medium along with the rotating body, and a heating unit that heats the rotating body, the preprocessing unit being placed at the upstream side of the fixing unit in a transport direction of the recording medium, and performing preprocessing by which a portion of the carrier liquid is removed from the recording medium.

### CROSS-REFERENCE TO RELATED APPLICATIONS

This application is based on and claims priority under 35 USC 119 from Japanese Patent Application No. 2013-143884 filed Jul. 9, 2013.

### BACKGROUND

### Technical Field

The invention relates to a fixing device, and an image forming apparatus.

### SUMMARY

According to an aspect of the invention, there is provided a fixing device, including:

a fixing unit that fixes a toner image developed by a developer including toner and a carrier liquid to a recording medium; and

a preprocessing unit that includes a metallic rotating body that is placed on the toner image side of the recording medium and rotates, a pressure member that includes an elastic layer and pressurizes the recording medium along with the rotating body, and a heating unit that heats the rotating body,

the preprocessing unit being placed at the upstream side of the fixing unit in a transport direction of the recording medium, and performing preprocessing by which a portion of the carrier liquid is removed from the recording medium.

### BRIEF DESCRIPTION OF THE DRAWINGS

Exemplary embodiments of the present invention will be described in detail based on the following figures, wherein:

FIG. 1 is a schematic diagram showing an overall configuration of an image forming apparatus according to the present exemplary embodiment;

FIG. 2 is a schematic diagram showing a configuration of a fixing device according to the present exemplary embodiment;

FIGS. 3A to 3E are schematic diagrams explaining a mechanism that removes a carrier liquid existing on a sheet in a carrier liquid removing portion according to the present exemplary embodiment;

FIG. 4 is a graph showing a relationship between a passing frequency of the sheet and a residual quantity of the carrier liquid at a contact portion in the carrier liquid removing portion according to the present exemplary embodiment;

FIG. 5 is a graph showing relationships among the passing frequency of the sheet, a gloss of a toner image, and the residual quantity of the carrier liquid at a contact portion in the carrier liquid removing portion according to the present exemplary embodiment;

FIG. 6 is a graph showing relationships among the passing frequency of the sheet, the gloss of the toner image, and the residual quantity of the carrier liquid at a nip portion in the fixing portion according to the present exemplary embodiment;

FIG. 7 is a graph showing a relationship between the passing frequency of the sheet and the residual quantity of the carrier liquid at the contact portion when a temperature of a metal roll is changed in the carrier liquid removing portion according to the present exemplary embodiment;

FIG. 8 is a graph when the relationships between the passing frequency of the sheet and the temperature in the carrier liquid removing portion according to the present exemplary embodiment are compared using a toner K, a toner M, and the sheet;

FIG. 9 is a graph when relationships among the passing frequency of the sheet, the gloss of the toner image, and the residual quantity of the carrier liquid in the fixing portion of the present exemplary embodiment are compared according to the presence or absence of an oil recovery member;

FIG. 10 is a schematic diagram showing a configuration of a fixing device according to a first modification example;

FIG. 11 is a graph when the relationships between the passing frequency of the sheet and the residual quantity of the carrier liquid at the contact portion in the carrier liquid removing portion according to the first modification example are compared according to a diameter of the metal roll;

FIG. 12 is a schematic diagram showing a configuration of a fixing device according to a second modification example;

FIG. 13A is a schematic diagram showing a configuration of a fixing device according to a third modification example;

FIG. 13B is a schematic diagram showing a configuration of a fixing device according to a fourth modification example; and

FIG. 13C is a schematic diagram showing a configuration of a fixing device according to a fifth modification example.

### DETAILED DESCRIPTION

Hereinafter, examples of a fixing device and an image forming apparatus of the present exemplary embodiment will be described with reference to the drawings. First, an overall configuration and an operation of the image forming apparatus will be described, and subsequently, a configuration and an operation of the fixing device that is a main portion of the present exemplary embodiment will be described.

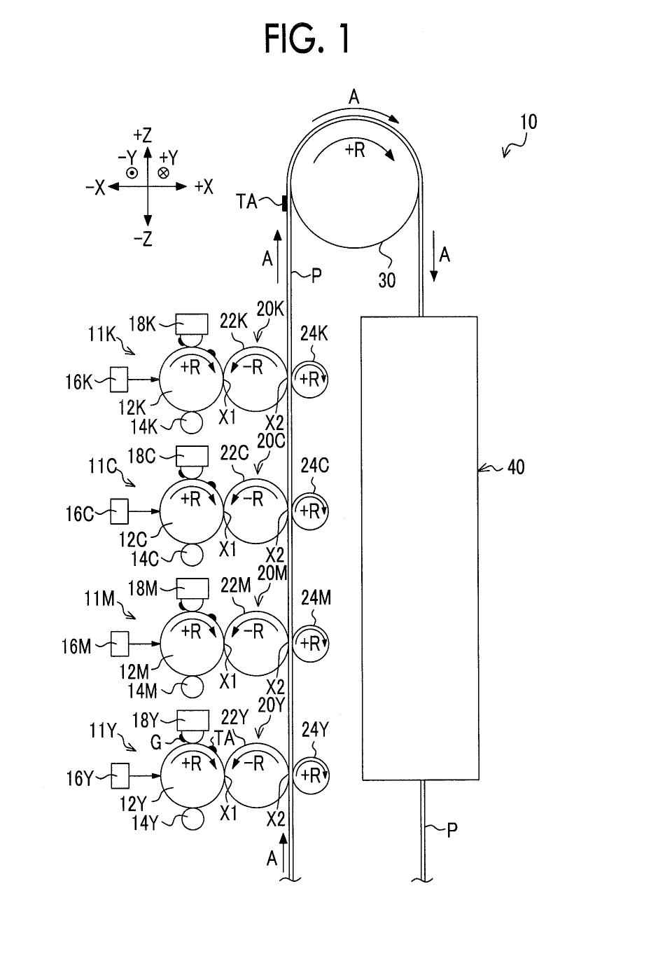

Moreover, in the descriptions below, a direction indicated by an arrow Z shown in FIG. 1 represents an apparatus height direction, and a direction indicated by an arrow X shown in FIG. 1 represents an apparatus width direction. Moreover, a direction (indicated by Y), which is orthogonal to the apparatus height direction and the apparatus width direction respectively, represents an apparatus depth direction. In addition, when an image forming apparatus 10 is viewed from a side at which a user (not shown) stands (in a front view), the apparatus height direction, the apparatus width direction, and the apparatus depth direction are indicated by a Z direction, an X direction, and a Y direction.

Moreover, in a case where it is necessary to distinguish one side and the other side in each of the X direction, the Y direction, and the Z direction, when the image forming apparatus 10 is viewed from the front side, an upper side is indicated by a +Z side, a lower side is indicated by a −Z side, a right side is indicated by a +X side, a left side is indicated by a −X side, a rear side is indicated by a +Y side, and a front side is indicated by a −Y side.

[Overall Configuration]

As shown in FIG. 1, the image forming apparatus 10 includes four image forming units 11Y, 11M, 11C, and 11K, four transfer devices 20Y, 20M, 20C, and 20K, a transport roll 30 that configures a portion of a transport device (not shown), and a fixing device 40. Moreover, a subscript “Y” indicates for yellow, a subscript “M” indicates for magenta, a subscript “C” indicates for cyan, and a subscript “K” indicates for black. In addition, each unit corresponding to each color in the image forming apparatus 10 is placed so that Y, M, C, and K are arranged in this order from an upstream side along a transport direction of a sheet P described below.

The transport device (not shown) transports the sheet P, which is an example of a recording medium, in an arrow A direction (transport direction) shown in FIG. 1 at a predetermined transport speed. The sheets P are consecutive sheets, and as an example, in the transport direction, the sheet is transported from the −Z side to the +Z side at the upstream side of the transport roll 30, and the sheet is transported from the +Z side to the −Z side at the downstream side of the transport roll 30. Moreover, in the transport direction of the sheet P, the transport roll 30 is disposed at the downstream sides of the four image forming units 11Y, 11M, 11C, and 11K, and the four transfer devices 20Y, 20M, 20C, and 20K, and the fixing device 40 is placed at the downstream side of the transport roll 30. The operation of each portion of the image forming apparatus 10 is controlled by a controller (not shown).

The image forming units 11Y, 11M, 11C, and 11K include cylindrical photoconductors 12Y, 12M, 12C, and 12K as examples of image holding members holding electrostatic latent images, respectively. In addition, the image forming units 11Y, 11M, 11C, and 11K include charging devices 14Y, 14M, 14C, and 14K, exposure devices 16Y, 16M, 16C, 16K, and developing devices 18Y, 18M, 18C, and 18K, respectively.

(Photoconductor)

Each of the photoconductors 12Y, 12M, 12C, and 12K is rotatable in an arrow +R direction (clockwise direction) shown in FIG. 1. Moreover, the charging devices 14Y, 14M, 14C, and 14K, the exposure devices 16Y, 16M, 16C, and 16K, and the developing devices 18Y, 18M, 18C, and 18K are placed around the photoconductors 12Y, 12M, 12C, and 12K in this order in the +R direction.

(Charging Device and Exposure Device)

The charging devices 14Y, 14M, 14C, and 14K charge the outer circumferential surfaces of the photoconductors 12Y, 12M, 12C, and 12K. The exposure devices 16Y, 16M, 16C, and 16K expose the outer circumferential surfaces of the photoconductors 12Y, 12M, 12C, and 12K, which are charged by the charging devices 14Y, 14M, 14C, and 14K, based on image data to form electrostatic latent images.

(Developing Device)

The developing devices 18Y, 18M, 18C, and 18K develop electrostatic latent images, which are formed on the outer circumferential surfaces of the photoconductors 12Y, 12M, 12C, and 12K by the exposure devices 16Y, 16M, 16C, and 16K, by a developer G to obtain visible toner images TA.

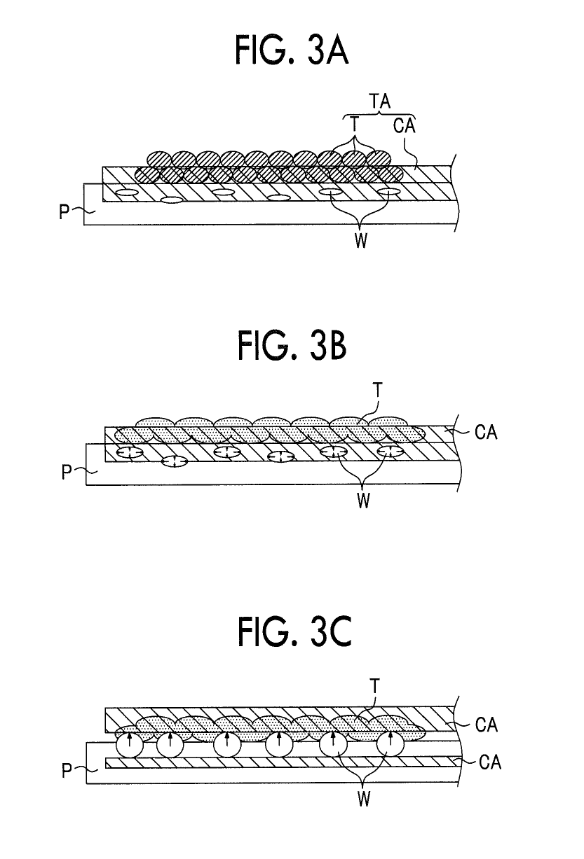

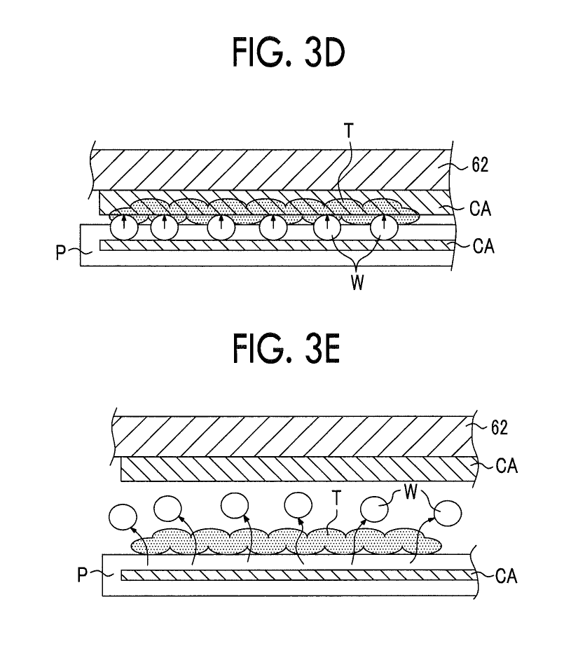

The developer G used in the developing devices 18Y, 18M, 18C, and 18K is a liquid developer that is obtained by dispersing powdered toner T (refer to FIG. 3A) in a carrier liquid CA (refer to FIG. 3A). The carrier liquid CA may include paraffin-based oil, ether-based oil, silicone-based oil, vegetable oil, or the like. However, the carrier liquid is not limited thereto. In the present exemplary embodiment, as an example, the toner T has a polyester resin as a main component and the carrier liquid CA is oil that has dimethylsilicone oil as a main component.

(Transfer Device)

The transfer devices 20Y, 20M, 20C, and 20K include intermediate transfer rolls 22Y, 22M, 22C, and 22K and backup rolls 24Y, 24M, 24C, and 24K. In addition, since the configuration of the transfer device 20Y is the same as the configurations of the transfer devices 20M, 20C, and 20K except for the toner T (refer to FIG. 3A), here, the transfer device 20Y is described, and the descriptions of the transfer devices 20M, 20C, and 20K are omitted.

The intermediate transfer roll 22Y contacts the photoconductor 12Y at a primary transfer position X1 that is positioned at the upstream side of the charging device 14Y and at the downstream side of the developing device 18Y in the rotation direction of the photoconductor 12Y, and rotates following the rotation of the photoconductor 12Y in a direction (counterclockwise direction) shown by an arrow −R. Accordingly, in the transfer device 20Y, the toner image TA formed on the surface of the photoconductor 12Y by the development is primarily transferred to the intermediate transfer roll 22Y at the primary transfer position X1. Moreover, when the toner image TA is primarily transferred to the intermediate transfer roll 22Y, the carrier liquid CA (refer to FIG. 3A) is also transferred to the intermediate transfer roll 22Y. In addition, a primary transfer voltage (bias voltage) is applied between the photoconductor 12Y and the intermediate transfer roll 22Y by a power source (not shown).

The backup roll 24Y is placed to face the intermediate transfer roll 22Y at a side opposite to the photoconductor 12Y. Moreover, the backup roll 24Y is rotated in the direction shown by the arrow +R when the sheet P is supplied between the intermediate transfer roll 22Y and the backup roll 24Y. Here, a position, at which the intermediate transfer roll 22Y and the sheet P contact each other, is a secondary transfer position X2, and the toner image TA that is primarily transferred to the intermediate transfer roll 22Y is secondarily transferred to the sheet P at the secondary transfer position X2. In addition, a secondary transfer voltage (bias voltage) is applied between the intermediate transfer roll 22Y and the backup roll 24Y. Moreover, when the toner image TA is secondarily transferred to the sheet P, the carrier liquid CA (refer to FIG. 3A) is also transferred to the sheet P.

(Image Forming Operation)

In the image forming apparatus 10, an image is formed as follows.

In the image forming unit 11Y, the photoconductor 12Y is rotated, and the outer circumferential surface of the photoconductor 12Y is charged by the charging device 14Y. Subsequently, the charged surface of the photoconductor 12Y is exposed and scanned by the exposure device 16Y, and a first color (Y) electrostatic latent image (not shown) is formed on the outer circumferential surface of the photoconductor 12Y. The electrostatic latent image is developed by the developing device 18Y, and the visible toner image TA is formed on the surface of the photoconductor 12Y.

The toner image TA reaches the primary transfer position X1 by the rotation of the photoconductor 12Y and is primarily transferred to the intermediate transfer roll 22Y by the primary transfer voltage. At this time, the carrier liquid CA (refer to FIG. 3A) is also transferred to the intermediate transfer roll 22Y along with the toner T. The toner image TA transferred to the intermediate transfer roll 22Y reaches the secondary transfer position X2 by the rotation of the intermediate transfer roll 22Y and is secondarily transferred to the sheet P by the secondary transfer voltage. At this time, the carrier liquid CA is also transferred to the sheet P.

Similarly, the toner images TA of a second color (M), a third color (C), and a fourth color (K) formed by the image forming units 11M, 11C, and 11K are sequentially transferred to be overlapped on the sheet P via the intermediate transfer rolls 22M, 22C, and 22K. In addition, a transport speed of the sheet P and rotational speeds of the photoconductors 12Y, 12M, 12C, and 12K are synchronized with each other so that the positions of the toner images TA of each color are not deviated on the sheet P. Accordingly, multiple toner images TA are formed on the sheet P. The multiple toner images TA are heated and pressed at the fixing device 40 described below, and are fixed on the sheet P.

The photoconductor 12Y, at which the primary transfer of the toner image TA to the intermediate transfer roll 22Y ends, is cleaned by a cleaner (not shown), and thus, the remaining carrier liquid CA or the like is removed. Moreover, the outer circumferential surface of the intermediate transfer roll 22Y, at which the secondary transfer of the toner image TA to the sheet P ends, is also cleaned by a cleaner (not shown), and the remaining carrier liquid CA or the like is removed.

In addition, when a monochromatic image is formed on the sheet P, for example, when the black (K) image is formed, the other image forming units 11Y, 11M, and 11C are separated (retracted) from the intermediate transfer rolls 22Y, 22M, and 22C.

[Main Portion Configuration]

Next, the fixing device 40 will be described.

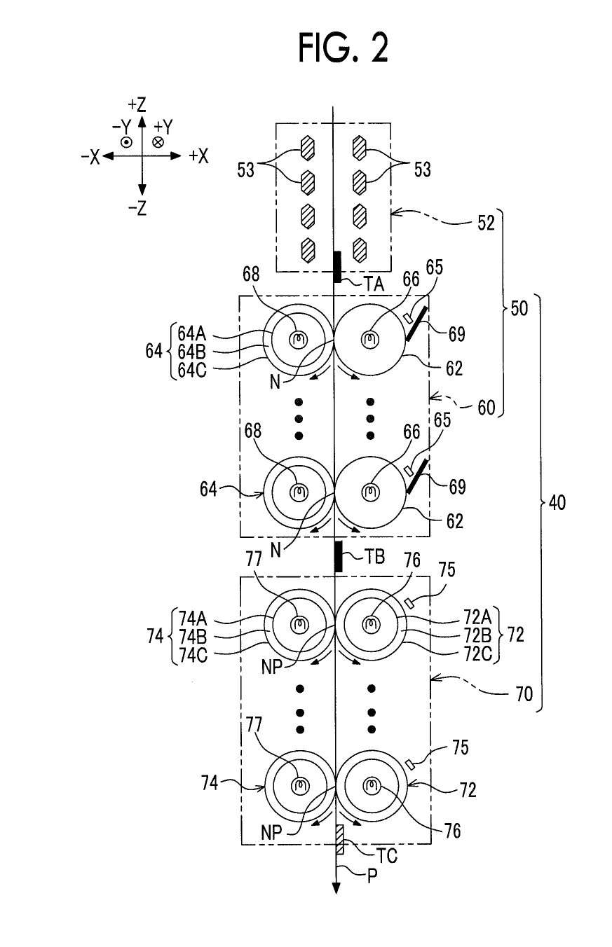

As shown in FIG. 2, as an example, the fixing device 40 includes a preprocessing portion 50 that is an example of a preprocessing unit performing preprocessing by which a portion of the carrier liquid CA (refer to FIG. 3A) is removed, and a fixing portion 70 that is an example of a fixing unit fixing a toner image TB on the sheet P after the preprocessing. That is, the preprocessing portion 50 is placed at the upstream side of the fixing portion 70 in the transport direction of the sheet P.

<Preprocessing Portion>

The preprocessing portion 50 includes an auxiliary heating portion 52 that is an example of an upstream side heating portion that heats the sheet P and the toner image TA on the sheet P, and a carrier liquid removing portion 60 that is placed at the downstream side of the auxiliary heating portion 52 in the transport direction of the sheet P. The carrier liquid removing portion 60 includes a metal roll 62 that is an example of a rotating body, a pressure roll 64 that is an example of a pressure member, a halogen heater 66 that is an example of a heating unit for heating the metal roll 62, and a recovery blade 69 that is an example of a recovery member. Moreover, the carrier liquid removing portion 60 includes a halogen heater 68 that heats the pressure roll 64.

(Auxiliary Heating Portion)

As an example, the auxiliary heating portion 52 includes eight carbon heaters 53. The carbon heaters 53 are provided four by four at each of the +X side and the −x side of the sheet P at the upstream side of the metal roll 62 in the transport direction of the sheet P, and are placed in a non-contact manner with respect to the sheet P. Moreover, the carbon heaters 53 radiate infrared light to the sheet P by electric conduction to heat the sheet P and the toner image TA. In the present exemplary embodiment, as an example, outputs of the carbon heaters 53 are set so that the sheet P is 90° C. and the toner image TA on the sheet P is 110° C.

(Metal Roll)

As an example, the metal roll 62 is made of aluminum and is formed in a cylinder shape. Moreover, the metal roll 62 is provided to be rotatable at the +X side (toner image TA side) of the sheet P with the Y direction as the axial direction. In addition, the outer circumferential surface of the metal roll 62 reaches a mirror-surface state by grinding. Specifically, as an example, in surface roughness of the metal roll 62, it is preferable that Ra≦1.0 μm be satisfied. In addition, six metal rolls 62 are provided at equal intervals in the transport direction (Z direction) of the sheet P. Moreover, an outer diameter of the metal roll 62 is substantially the same as an outer diameter of the pressure roll 64. Moreover, in FIG. 2, two metal rolls 62 are shown, and the remaining four metal rolls 62 are not shown.

(Recovery Blade)

The recovery blade 69 is configured of a plate-like rubber member having improved oil resistance and abrasion resistance, and as an example, fluororubber is used. In addition, the recovery blade 69 contacts the outer circumferential surface of the metal roll 62 so that one end of the recovery blade faces a direction opposite to the rotation direction of the metal roll 62. Accordingly, the carrier liquid CA (refer to FIG. 3A) adhering to the outer circumferential surface of the metal roll 62 is recovered by the recovery blade 69 according to the rotation of the metal roll 62. In addition, in FIG. 2, two recovery blades 69 are shown, and the remaining four recovery blades 69 are not shown.

(Pressure Roll)

As an example, the pressure roll 64 is formed in a cylinder shape, and is provided to be rotatable at the −x side of the sheet P with the Y direction as the axial direction. In addition, the pressure roll 64 has a multilayer structure that includes a base layer 64A, an elastic layer 64B, and a release layer 64C from the inner side to the outer side in the radial direction. Moreover, six pressure rolls 64 are provided at equal intervals in the Z direction so as to face the metal rolls 62 while interposing the sheet P, and pressurize the sheet P along with the metal rolls 62. In addition, in FIG. 2, two pressure rolls 64 are shown, and the remaining four pressure rolls 64 are not shown. Moreover, a portion, in which the metal roll 62 and the pressure roll 64 contact each other in a state where the sheet P does not exist, is represented by a contact portion N. The metal roll 62 rotates at substantially a constant speed. However, the pressure roll 64 rotates at a speed lower than that of the metal roll 62.

As an example, the base layer 64A is made of stainless steel (SUS). Moreover, as an example, the elastic layer 64B is made of a silicon rubber. In addition, as an example, the release layer 64C is made of tetrafluoroethylene-perfluoroalkoxy-ethylene copolymer (PFA).

(Halogen Heater)

The halogen heaters 66 are inserted one by one along the Y direction in the inside of each metal roll 62. Moreover, each halogen heater 66 generates heat by electric conduction from the power source (not shown) and heats the metal roll 62 from the inside. In addition, as an example, each halogen heater 66 is feedback-controlled based on an output of a temperature sensor 65 that detects the temperature of the metal roll 62 so that the temperature of the outer circumferential surface of the metal roll 62 is 120° C.

Meanwhile, the halogen heater 68 is inserted along the Y direction in the inside of each pressure roll 64. In addition, the halogen heater 68 generates heat by electric conduction from the power source (not shown) and heats the pressure roll 64 from the inside. Moreover, as an example, the halogen heater 68 is feedback-controlled based on an output of a temperature sensor (not shown) that detects the temperature of the pressure roll 64 so that the temperature of the outer circumferential surface of the metal roll 62 is maintained at 120° C.

Here, six metal rolls 62 can move to either the −X side (contact side) or the +x side (retracting side) by a retract mechanism portion (not shown) with positions, at which the outer circumferential surfaces are separated from the sheet P, as origin positions. Similarly, six pressure rolls 64 can move to either the +X side (contact side) or the −X side (retracting side) by the retract mechanism portion (not shown) with positions, at which the outer circumferential surfaces are separated from the sheet P, as origin positions.

When the fixing is performed by the fixing portion 70 described below, the retract mechanism portion (not shown) moves six metal rolls 62 to the −X side and moves six pressure rolls 64 to the +X side to interpose the sheet P between the metal rolls and the pressure rolls. Moreover, when the fixing is not performed by the fixing portion 70, the retract mechanism portion moves six metal rolls 62 to the +X side and moves six pressure rolls 64 to the −X side to retract the metal rolls and the pressure rolls from the sheet P. Moreover, the halogen heaters 66 and the recovery blades 69 are moved in a state where the placement with respect to the metal rolls 62 is maintained, and the halogen heaters 68 are moved in a state where the placement with respect to the pressure rolls 64 is maintained.

<Fixing Portion>

The fixing portion 70 includes fixing rolls 72 that are examples of fixing rotating bodies, and opposite rolls 74 that are opposite to the fixing rolls 72 while interposing the sheet P therebetween. Moreover, in the fixing portion 70, as an example, three sets of the fixing rolls 72 and the opposite rolls 74 are placed with an interval in the transport direction (Z direction) of the sheet P.

(Fixing Roll)

The fixing roll 72 is formed in a cylinder shape, and is provided to be rotatable at the +X side of the sheet P with the Y direction as the axial direction. In addition, the fixing roll 72 has a multilayer structure that includes a base layer 72A, an elastic layer 72B, and a release layer 72C from the inner side to the outer side in the radial direction. That is, in the fixing roll 72, the release layer 72C that contacts the toner image TB is formed on the outer circumferential surface of the elastic layer 72B. Moreover, in FIG. 2, two fixing rolls 72 are shown, and the remaining one fixing roll 72 is not shown.

As an example, the base layer 72A is made of SUS. As an example, the elastic layer 72B is made of a silicon rubber. As an example, the release layer 72C is made of PFA.

Moreover, a halogen heater 76 is provided inside the fixing roll 72. Moreover, the halogen heater 76 generates heat by electric conduction from the power source (not shown) and heats the fixing roll 72 from the inside. In addition, as an example, each halogen heater 76 is feedback-controlled based on an output of a temperature sensor 75 that detects the temperature of the fixing roll 72 so that the temperature of the outer circumferential surface of the fixing roll 72 is maintained at 130° C.

(Opposite Roll)

As an example, the opposite roll 74 is formed in a cylinder shape, and is provided to be rotatable at the −x side of the sheet P with the Y direction as the axial direction. In addition, the opposite roll 74 has a multilayer structure that includes abase layer 74A, an elastic layer 74B, and a release layer 74C from the inner side to the outer side in the radial direction. Moreover, the opposite roll 74 is provided so as to face the fixing roll 72 while interposing the sheet P, and pressurizes the sheet P along with the fixing roll 72. In addition, in FIG. 2, two opposite rolls 74 are shown, and the remaining one opposite roll 74 is not shown. Moreover, a portion, at which the fixing roll 72 and the opposite roll 74 contact each other in a state where the sheet P does not exist, is represented by a nip portion NP.

As an example, the base layer 74A is made of SUS. As an example, the elastic layer 74B is made of a silicon rubber. As an example, the release layer 74C is made of PFA.

Moreover, a halogen heater 77 is provided inside the opposite roll 74. Moreover, the halogen heater 77 generates heat by electric conduction from the power source (not shown) and heats the opposite roll 74 from the inside. In addition, as an example, each halogen heater 77 is feedback-controlled based on an output of a temperature sensor (not shown) that detects the temperature of the opposite roll 74 so that the temperature of the outer circumferential surface of the fixing roll 72 is maintained at 130° C.

[Operation]

Next, an operation of the present exemplary embodiment will be described.

(Mechanism of Carrier Liquid Removal)

FIG. 3A schematically shows a state where the toner image TA is transferred to the sheet P by the transfer devices 20Y, 20M, 20C, and 20K (refer to FIG. 1). In FIGS. 3A to 3E, a reference numeral T indicates the toner, a reference numeral CA indicates the carrier liquid, and a reference numeral W indicates water which exists in the sheet P. As an example, the toner T adheres to the surface of the sheet P in a state where the toner is overlapped with approximately two layers. The carrier liquid CA exists across the regions of the sheet P and the toner T. Moreover, in FIG. 3A to FIG. 3E, a state where the toner T is solidified is indicated by hatching, and a state where the toner T is semi-melted is indicated by dots.

Subsequently, as shown in FIG. 2, the toner TA on the sheet P transported to the auxiliary heating portion 52 is heated by the eight carbon heaters 53. Accordingly, as shown in FIG. 3B, the temperature of the toner T is from a flow starting temperature to a melting point, and thus, the toner T reaches a semi-melted state. Moreover, the water W existing in the sheet P is expanded by the heating of the carbon heater 53 (refer to FIG. 2) and begins to be vaporized.

Subsequently, at the time when the heating of the sheet P by the carbon heaters 53 (refer to FIG. 2) ends, as shown in FIG. 3C, the vaporized water W moves a portion of the carrier liquid CA exiting in the sheet P to extrude the portion outside the surface of the sheet P in a liquid state by a discharging force of the vaporized water. Accordingly, a portion of the carrier liquid CA floats outside the surface of the sheet P.

Subsequently, the sheet P and the toner image TA are transported to the carrier liquid removing portion 60 (refer to FIG. 2). In addition, in the carrier liquid removing portion 60, as shown in FIG. 3D, the metal roll 62 rotates while contacting the carrier liquid CA that floats outside the surface of the sheet P.

Subsequently, as shown in FIG. 3E, since affinity between the floating carrier liquid CA and the metal roll 62 is higher than affinity between the floating carrier liquid CA and the toner T, a portion of the carrier liquid is removed according to the rotation of the metal roll 62. Accordingly, the carrier liquid CA existing in the sheet P is decreased. Moreover, if the carrier liquid CA floating outside the surface of the sheet P is removed, the vaporized water W is discharged outside the sheet P. In addition, since the carrier liquid CA floats to be closer to the metal roll 62 than the toner T, the melted toner T is suppressed from being removed by the metal roll 62.

Subsequently, as shown in FIG. 2, after the toner image TA on the sheet P passes through the remaining 5 contact portions N in the carrier liquid removing portion 60, the toner image TA passes through 3 nip portions NP in the fixing portion 70. Accordingly, the toner image TB is fixed to the sheet P, and thus, a toner image TC is obtained. Moreover, the toner image before a portion of the carrier liquid CA is removed is indicated by the toner image TA, and the toner image in which a portion of the carrier liquid CA is removed and a ratio of the toner T is increased is indicated by TB to be distinguished from each other.

(Removal Performance Evaluation of Carrier Liquid)

Next, a result of removal performance evaluation of the carrier liquid CA (refer to FIG. 3A) in the preprocessing portion 50 will be described. Moreover, each member will be described with reference to FIG. 2.

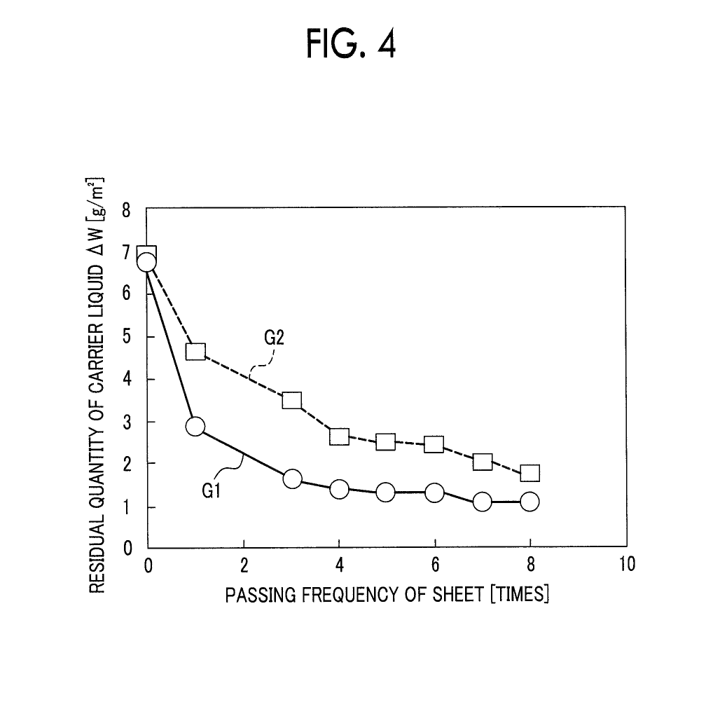

In FIG. 4, when a passing frequency of the sheet P (at the contact portion N) between the metal roll 62 and the pressure roll 64 is changed to 0, 1, 3, 4, 5, 6, 7, and 8, a residual quantity ΔW [g/m²] of the carrier liquid CA in the toner image TA is shown. Moreover, when the frequency, in which the sheet P passes through the contact portion N between one metal roll 62 and one pressure roll 64, is set to 1, in the liquid removing portion 60 (refer to FIG. 2), the passing frequency is a total number of the contact portions N through which the sheet P passes.

The metal rolls 62 and the pressure rolls 64 are heated to the above-described set temperatures. Moreover, the residual quantity ΔW of the carrier liquid CA is obtained by a difference between a weight WA [g/m²] per unit area of the toner image TA immediately after the toner image TA is transferred to the sheet P, and a weight WB [g/m²] per unit area of the carrier liquid CA that is recovered by the metal roll 62.

A graph G1 in FIG. 4 shows a measurement result when the metal roll 62 and the pressure roll 64 of the present exemplary embodiment are used. Moreover, as a comparative example, a graph G2 shows a measurement result when a rubber roll (not shown), in which an outermost layer is an elastic layer made of a silicon rubber, and the pressure roll 64 are used. In addition, a difference between the residual quantity of the carrier liquid CA on the sheet P when the passing frequency is 0 and the residual quantity of the carrier liquid CA on the sheet P at each passing frequency becomes a removal quantity of the carrier liquid CA that is removed by the metal roll 62.

Here, in both of the graphs G1 and G2, it is confirmed that the residual quantity ΔW of the carrier liquid CA is decreased as the passing frequency is increased from 1 to 4. In addition, with the configuration of the present exemplary embodiment, when the passing frequency is 4 or more, it is confirmed that the residual quantity ΔW of the carrier liquid CA remains at the same level. Moreover, in the passing frequency from 1 to 8, compared to when the rubber roll of the comparative example is used, in the case where the metal roll 62 and the pressure roll 64 of the present exemplary embodiment are used, it is confirmed that the residual quantity ΔW of the carrier liquid CA in the toner image TB is smaller.

(Gloss Evaluation of Toner Image)

Next, a result of a gloss evaluation of the toner image TB immediately after the carrier liquid CA is removed in the preprocessing portion 50 will be described. Moreover, each member will be described with reference to FIG. 2.

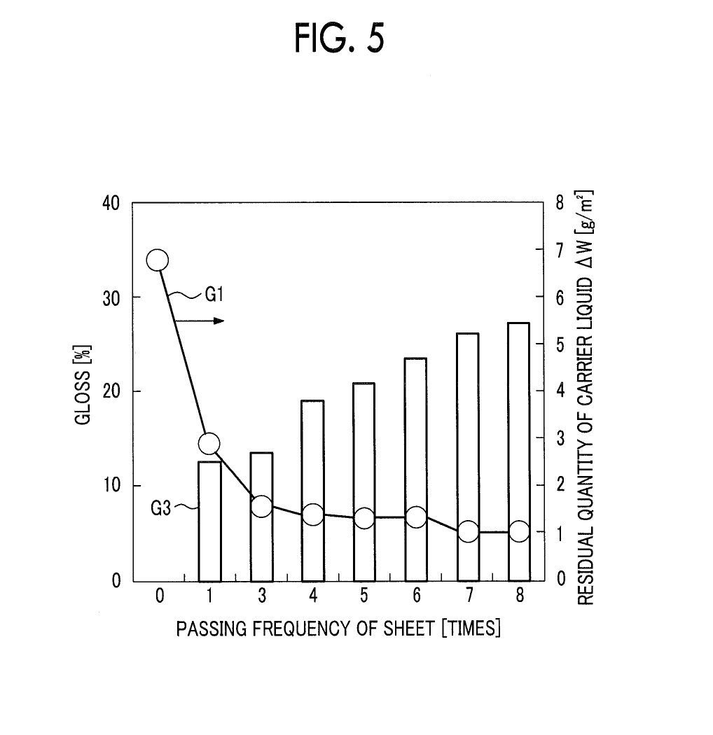

FIG. 5 shows the gloss (graph G3) of the toner image TB and the residual quantity ΔW (graph G1) of the carrier liquid CA when the passing frequency of the contact portion N of the sheet P (including the toner image TA) is changed to 0, 1, 3, 4, 5, 6, 7, and 8. The gloss % in the present exemplary embodiment is an index indicating glossiness in which light is incident to an object to be measured at a condition of 60% in an incident angle and the reflected light is measured (refer to JIS Z 8741). Moreover, in the present exemplary embodiment, as an example, the gloss is evaluated using micro-TRI-gloss manufactured by BYK-Gardner.

In FIG. 5, a tendency is confirmed in which the residual quantity ΔW of the carrier liquid CA is decreased and the gloss is increased as the passing frequency of the contact portion N is increased. In the present exemplary embodiment, as an example, 30% is a desired value in the gloss of the toner image TB. However, the obtained gloss is approximately 27% even when the passing frequency of the contact portion N of the sheet P is 8, and thus, the gloss is lower than 30%. This is considered to be because the surface of the toner image TB follows minute irregularities on the surface of the metal roll 62.

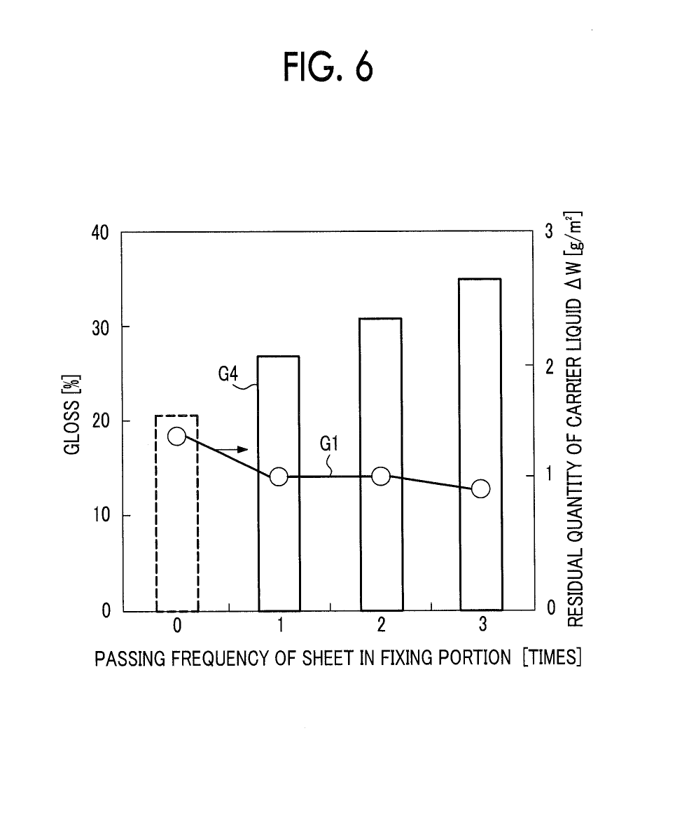

FIG. 6 shows the gloss (graph G4) of the toner image TB and the residual quantity ΔW (graph G1) of the carrier liquid CA when the passing frequency of the nip portion NP of the sheet P (including the toner image TB) is changed to 0, 1, 2, and 3 in the fixing portion 70. In addition, in each frequency, the passing frequency of the contact portion N in the preprocessing portion 50 is set to 4 so as to be the same condition. Moreover, the measurement method of the gloss is as described above.

In FIG. 6, a tendency is confirmed in which the gloss of the toner image TB is increased as the passing frequency of the nip portion NP is increased. Moreover, it is confirmed that the gloss is higher than 30% if the passing frequency of the nip portion NP of the sheet P is 2 or more. That is, in the fixing device 40 of the present exemplary embodiment, it is confirmed that the gloss higher than 30% is obtained in the toner image TB after fixing the toner image to the sheet P.

(Evaluation of Residual Quantity of Carrier Liquid and Toner Offset)

Next, results will be described in which the residual quantity ΔW of the carrier liquid CA and an offset of the toner T at the metal roll 62 are evaluated. Moreover, each member will be described with reference to FIG. 2.

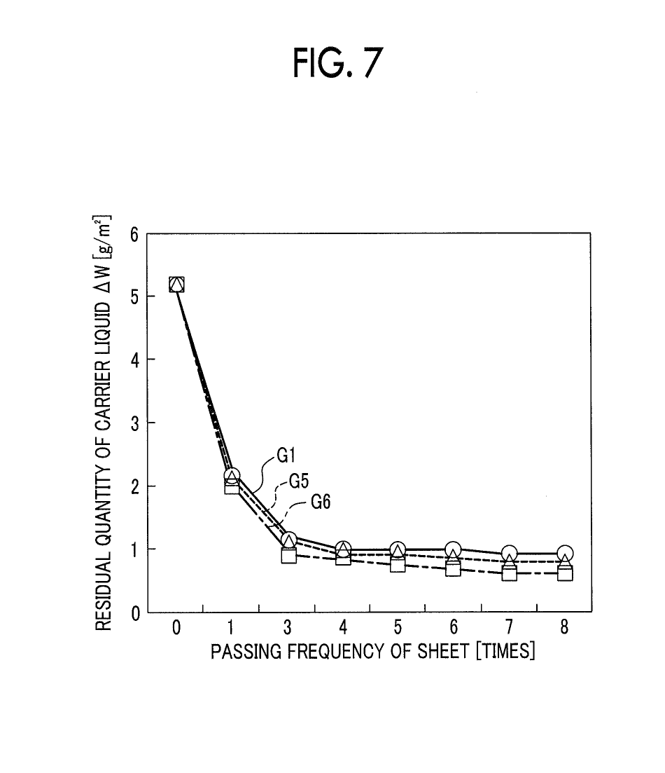

FIG. 7 shows results in which the residual quantity ΔW of the carrier liquid CA is evaluated by changing the temperature of the metal roll 62 when the passing frequency of the contact portion N of the sheet P (toner image TA) is changed to 0, 1, 3, 4, 5, 6, 7, and 8. A graph G1 shows a case where the temperature of the outer circumferential surface of the metal roll 62 is 120° C., a graph G5 shows a case where the temperature of the outer circumferential surface of the metal roll 62 is 130° C., and a graph G6 shows a case where the temperature of the outer circumferential surface of the metal roll 62 is 140° C.

Here, as shown in FIG. 7, in the graphs G1, G5, and G6, there are no differences among the residual quantities ΔW of the carrier liquid CA. That is, in the present exemplary embodiment, even when the temperature of the metal roll 62 is changed in a range from 120° C. to 140° C., it is confirmed that the residual quantity ΔW of the carrier liquid CA almost does not change.

Meanwhile, after the set temperature of the metal roll 62 is changed to 120° C., 130° C., and 140° C. and the carrier liquid CA is removed, the outer circumferential surface of the metal roll 62 at each passing frequency (1, 3, 4, 5, 6, 7, and 8) is visually evaluated, and the results are shown in Table 1. The visual evaluation is performed by two-way evaluation in which a case where adhesion of the toner T is not found on the outer circumferential surface of the metal roll 62 is indicated by A, and a case where adhesion of the toner T is found on the outer circumferential surface of the metal roll 62 is indicated by B.

TABLE 1

| Temperature | Passing Frequency of Sheet | | | | | | |
|---|---|---|---|---|---|---|---|
| ° C. | 1 | 3 | 4 | 5 | 6 | 7 | 8 |
| 120 | A | A | A | A | A | A | A |
| 130 | A | A | A | A | A | A | A |
| 140 | B | B | B | B | B | B | B |

As shown in Table 1, the case where the set temperature of the metal roll 62 is 120° C. and 130° C. is indicated by A, and the case where the set temperature of the metal roll 62 is 140° C. is indicated by B. That is, if the set temperature of the metal roll 62 is 140° C., it is confirmed that an offset of the toner T to the metal roll 62 occurs. In the present exemplary embodiment, since the set temperature of the metal roll 62 is 120° C., the offset of the toner T to the metal roll 62 almost does not occur. Moreover, since the set temperature of the metal roll 62 is appropriately set according to a glass transition temperature or a melting temperature of the used toner T, the set temperature is not limited to 120° C.

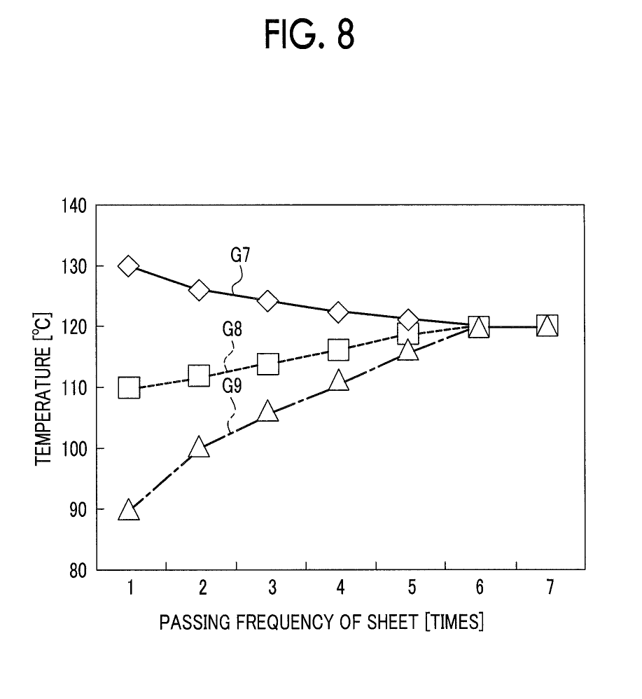

Here, FIG. 8 shows temperatures of the toner K (black), the toner M (magenta), and the sheet P when the set temperature of the metal roll 62 is 120° C. and the passing frequency of the contact portion N of the sheet P is changed to 1, 2, 3, 4, 5, 6, and 7. A graph G7 indicates the temperature of the toner K, a graph G8 indicates the temperature of the toner M, and a graph G9 indicates the temperature of the sheet P, respectively. In addition, each temperature is measured in a non-contact state using a radiation thermometer.

As shown in FIG. 8, respective temperatures of the toner K, the toner M, and the sheet P converge toward 120° C. whenever the sheet passes through the contact portion N (refer to FIG. 2), and if the passing frequency is 6 or more, it is confirmed that respective temperatures become 120° C. That is, since the plural metal rolls 62 are used, the temperatures of the toner image (TB) (refer to FIG. 2) and the sheet P are approximately the same as each other regardless of the kinds (Y, M, C, and K) of the toner T, and fixity of the toner image TB to the sheet P is stabilized.

(Evaluation of Oil Recovery Member in Fixing Portion)

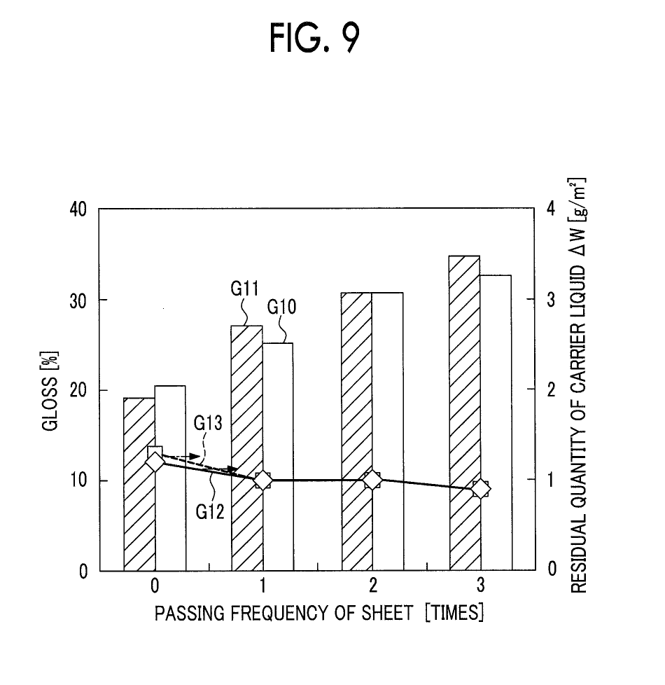

FIG. 9 shows the gloss (graphs G10 and G11) of the toner image TB and the residual quantity ΔW (graphs G12 and G13) of the carrier liquid CA when the passing frequency of the nip portion NP of the sheet P (including the toner image TB) is changed to 0, 1, 2, and 3 in the fixing portion 70. Here, when the frequency, in which the sheet P passes through the nip portion NP between one fixing roll 72 and one opposite roll 74, is set to 1, in the fixing portion 70 (refer to FIG. 2), the passing frequency is a total number of the nip portions NP through which the sheet P passes. In addition, in each frequency, the passing frequency of the contact portion N in the preprocessing portion 50 is set to 4 so as to be the same condition. However, the passing frequency in the preprocessing portion may be set to 6. Moreover, the measurement method of the gloss is as described above, and each member will be described with reference to FIG. 2.

The graph G10 shows the change of the gloss of the toner image TB in the fixing portion 70 of the present exemplary embodiment. Moreover, in the present exemplary embodiment, the oil recovery member does not contact the outer circumferential surface of the fixing roll 72. On the other hand, as a comparative example, the graph G11 shows the change of the gloss of the toner image TB when a plate-like oil recovery member (not shown) contacts the outer circumferential surface of the fixing roll 72.

The graph G12 shows the residual quantity ΔW of the carrier liquid CA of the sheet P before the sheet enters the fixing portion 70 of the present exemplary embodiment. On the other hand, as a comparative example, the graph G13 shows the residual quantity ΔW of the carrier liquid CA of the sheet P before the sheet enters the fixing portion 70 in the configuration that the plate-like oil recovery member (not shown) contacts the outer circumferential surface of the fixing roll 72.

Here, in both of the present exemplary embodiment and the comparative example, it is confirmed from the graphs G12 and G13 that the residual quantities of the carrier liquid CA of the sheets P before entering the fixing portion 70 are substantially the same as each other. That is, in the present exemplary embodiment and the comparative example, the sheets P having approximately the same residual quantity ΔW of the carrier liquid CA are transported to the fixing portion 70. Moreover, in both of the present exemplary embodiment and the comparative example, it is confirmed from the graphs G10 and G11 that the glosses after the toner image TB is fixed in the fixing portion 70 are substantially the same as each other.

From this, if the carrier liquid CA in the toner image TA is decreased to a certain extent according to removal of the carrier liquid CA by the metal roll 62, regardless of the presence or absence of the oil recovery member in the fixing portion 70, it is confirmed that the glosses of the toner image TB are the same as each other in the present exemplary embodiment and the comparative example. That is, even when the sheet P to which the carrier liquid CA is adhered passes through the nip portion NP of the fixing portion 70, since the carrier liquid CA does not interfere with the fixing of toner image TB, the oil recovery member does not need to contact the fixing roll 72. In addition, since the oil recovery member does not contact the fixing roll 72, a load acting on the surface of the fixing roll 72 is decreased, and thus, in the image forming apparatus 10 in which the fixing roll 72 is replaceable, the fixing roll 72 can be used for a long time.

(Operation of Fixing Device and Image Forming Apparatus)

As described above, in the fixing device 40 of the present exemplary embodiment, since the sheet P is heated by the auxiliary heating portion 52 in advance, the carrier liquid CA in the sheet P floats with respect to the toner T. Accordingly, the carrier liquid CA in the sheet P is removed by the metal roll 62. Moreover, in the fixing device 40, the metal roll 62 is used to remove the carrier liquid CA, the affinity between the metal roll 62 and the carrier liquid CA is higher (wettability is better) than the affinity between a rubber roll and the carrier liquid CA, and thus, compared to the configuration that uses the rubber roll, the removal quantity of the carrier liquid CA is increased.

Moreover, in the fixing device 40, in the contact portion N, the carrier liquid CA moves to the metal roll 62 by a force generated when distortion generated in the elastic layer 64B of the pressure roll 64 is released. Accordingly, compared to a configuration in which the pressure roll 64 does not include the elastic layer 64B, the quantity of the carrier liquid CA removed by the metal roll 62 is increased. Moreover, in the fixing device 40, the unnecessary carrier liquid CA in the toner image TA is removed, the heat and the pressure are transmitted from the fixing roll 72 to the toner T, and thus, the fixing of the toner can be performed. Accordingly, insufficient fixing of the toner T is suppressed when the toner image TA including the carrier liquid CA is fixed to the sheet P by the fixing device 40.

In addition, in the fixing device 40, since the carrier liquid CA is removed using the metal roll 62, compared to the configuration that uses the rubber roll, abrasion resistance is increased, and the metal roll 62 can be used for a long time.

Moreover, in the fixing device 40, since the plural metal rolls 62 and the plural pressure rolls 64 are arranged with an interval in the transport direction of the sheet P, compared to a configuration that includes one set of the metal roll 62 and the pressure roll 64, the carrier liquid CA is efficiently removed.

In addition, in the fixing device 40, the carrier liquid CA removed from the sheet P by the metal roll 62 is recovered from the metal roll 62 by the recovery blade 69. Accordingly, in the fixing device 40, compared to a configuration in which the carrier liquid CA adhering to the outer circumferential surface of the metal roll 62 is not recovered, the recovered carrier liquid CA is suppressed from adhering to the sheet P again according to the rotation of the metal roll 62.

Moreover, in the fixing device 40, since the carrier liquid CA includes dimethylsilicone oil having high affinity with metal, compared to a configuration that does not include the dimethylsilicone oil, the removal quantity of the carrier liquid CA in the metal roll 62 is increased.

In addition, in the fixing device 40, the toner T includes a polyester resin that has higher cohesiveness compared to other resins. Accordingly, when the carrier liquid CA in the toner image TA is removed by the metal roll 62, since the toner T including the polyester resin does not easily adhere to the metal roll 62, compared to a configuration that does not include the polyester resin, the insufficient fixing of the toner T to the sheet P is suppressed.

Moreover, in the fixing device 40, the release layer 72C is formed on the outer circumferential surface of the fixing roll 72 in the fixing portion 70. Accordingly, in the fixing device 40, compared to a configuration in which the fixing roll 72 does not include the release layer 72C, since the toner T does not easily adhere to the outer circumferential surface of the fixing roll 72, the fixity of the toner image TB in the fixing portion 70 is improved.

Moreover, in the image forming apparatus 10, since insufficient fixing of the toner T is suppressed, image defects of the toner image TC due to insufficient fixing are suppressed.

### MODIFICATION EXAMPLE

Next, as modification examples of the fixing device 40 of the present exemplary embodiment, first, second, third, fourth, and fifth modification examples will be described. Moreover, the same reference numerals as those of the fixing device 40 are associated with substantially the same members or portions as the fixing device 40 of the above-described present exemplary embodiment, and the descriptions thereof are omitted.

### First Modification Example

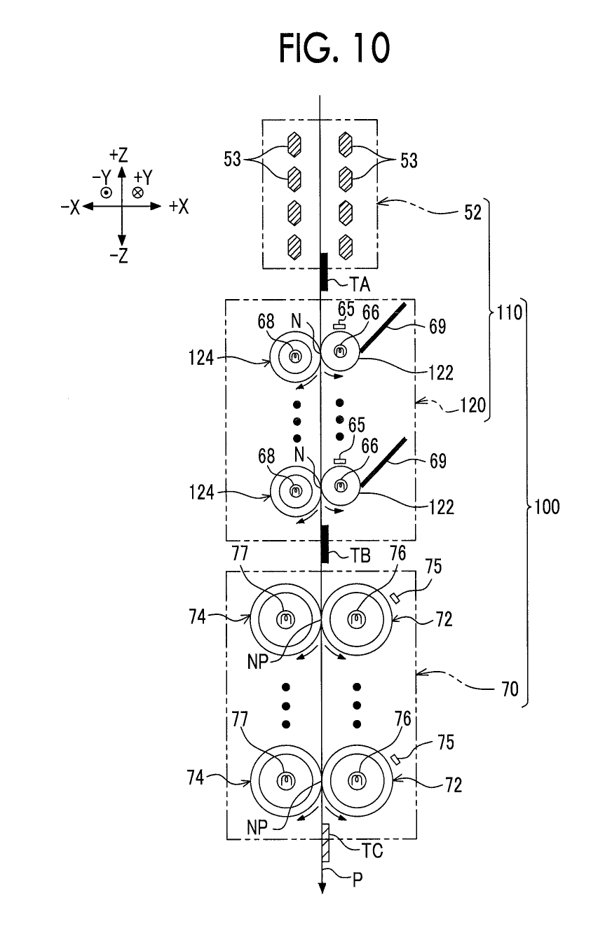

FIG. 10 shows a fixing device 100 according to the first modification example. The fixing device 100 is provided instead of the fixing device 40 (refer to FIG. 1) in the image forming apparatus 10 (refer to FIG. 1). Moreover, the fixing device 100 includes a preprocessing portion 110 that is an example of a preprocessing unit performing preprocessing by which a portion of the carrier liquid CA is removed, and the fixing portion 70.

The preprocessing portion 110 includes the auxiliary heating portion 52, and a carrier liquid removing portion 120 that is placed at the downstream side of the auxiliary heating portion 52 in the transport direction of the sheet P. The carrier liquid removing portion 120 includes a metal roll 122 that is an example of a rotating body, a pressure roll 124 that is an example of a pressure member, the halogen heater 66 that heats the metal roll 122, and the recovery blade 69. Moreover, the carrier liquid removing portion 120 includes the halogen heater 68 that heats the pressure roll 124.

The metal roll 122 has an outer diameter smaller than that of the above-described metal roll 62 (refer to FIG. 2), and as an example, the outer diameter is 50 mm. The material and the structure of the metal roll 122 are similar to those of the metal roll 62. In addition, six metal rolls 122 are provided at equal intervals in the Z direction. Moreover, in FIG. 10, two metal rolls 122 are shown, and the remaining four metal rolls 122 are not shown.

The pressure roll 124 has an outer diameter smaller than that of the above-described pressure roll 64 (refer to FIG. 2), and the material and the structure of the pressure roll 124 are similar to those of the pressure roll 64. In addition, six pressure rolls 124 are provided to be opposite to the metal rolls 122 at equal intervals in the Z direction. Moreover, in FIG. 10, two pressure rolls 124 are shown, and the remaining four pressure rolls 124 are not shown.

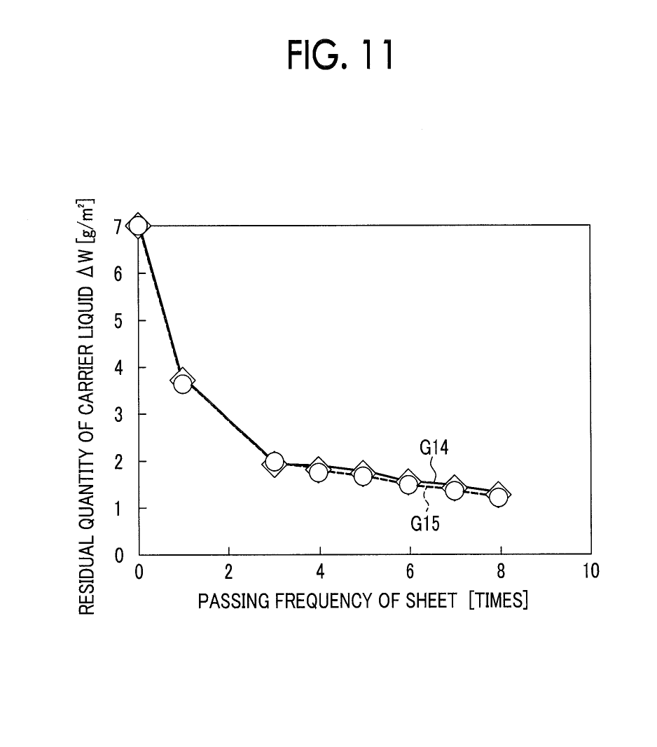

In FIG. 11, in the fixing device 100, when a passing frequency of the sheet P at the contact portion N between the metal roll 122 and the pressure roll 124 (refer to FIG. 10) is changed to 0, 1, 3, 4, 5, 6, 7, and 8, the residual quantity ΔW [g/m²] of the carrier liquid CA in the toner image TA is shown. Moreover, the frequency in which the sheet P passes through the contact portion N between one metal roll 122 and one pressure roll 124 is set to 1.

In FIG. 11, a graph G14 shows a measurement result when the fixing device 100 (refer to FIG. 10) is used, and a passage time t1 of the sheet P through the contact portion N (refer to FIG. 10) is 8 ms. As a comparative example, a graph G15 shows a measurement result when the outer diameter of the metal roll 122 is set to 120 mm and a passage time t2 of the sheet P through the contact portion N (refer to FIG. 10) is set to 16 ms.

Here, in both of the graphs G14 and G15, it is confirmed that the residual quantity ΔW of the carrier liquid CA is decreased as the passing frequency is increased from 1 to 4. In addition, in both of the graphs G14 and G15, when the passing frequency is 4 or more, it is confirmed that the residual quantity ΔW of the carrier liquid CA remains at the same level. In addition, in the graphs G14 and G15, it is confirmed that the residual quantities ΔW of the carrier liquid CA are approximately the same as each other.

That is, in the fixing device 100 shown in FIG. 10, even when the time required for removing the carrier liquid CA in the contact portion N is shortened, it is found that performance of removing the carrier liquid CA is not substantially influenced. Accordingly, the metal roll 22 having an outer diameter smaller than that of the metal roll 62 (refer to FIG. 2) may be used.

### Second Modification Example

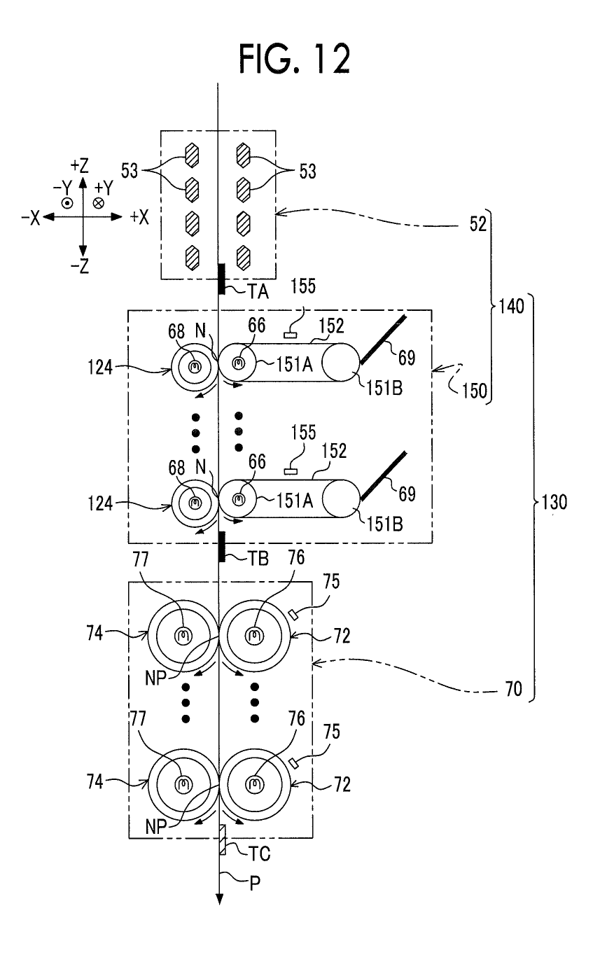

FIG. 12 shows a fixing device 130 according to the second modification example. The fixing device 130 is provided instead of the fixing device 40 (refer to FIG. 1) in the image forming apparatus 10 (refer to FIG. 1). Moreover, the fixing device 130 includes a preprocessing portion 140 that is an example of a preprocessing unit performing preprocessing by which a portion of the carrier liquid CA is removed, and the fixing portion 70.

The preprocessing portion 140 includes the auxiliary heating portion 52, and a carrier liquid removing portion 150 that is placed at the downstream side of the auxiliary heating portion 52 in the transport direction of the sheet P. The carrier liquid removing portion 150 includes a belt 152 that is wound around two rolls 151A and 151B and is an example of a rotating body, the pressure roll 124, the halogen heater 66 that is provided inside the roll 151A and heats the belt 152, and the recovery blade 69. In addition, the carrier liquid removing portion 150 includes a temperature sensor 155 that detects a temperature of the belt 152, and the halogen heater 68 that heats the pressure roll 124.

The belt 152 is made of metal, and as an example, is made of SUS. Moreover, an electroformed nickel belt or the like may be used as the belt 152. In addition, six belts 152 are provided at equal intervals in the Z direction. Moreover, in FIG. 12, two belts 152 are shown, and the remaining four belts 152 are not shown. In addition, in each of six belts 152, the pressure roll 124 contacts a portion of the belt 152 wound around the roll 151A, and thus, the contact portion N is formed. In this way, since the belt 152 is used in the preprocessing portion 140, a cross-sectional shape at an X-Z plane of the contact portion N and a width in the Z direction of the contact portion N can be changed.

### Third Modification Example

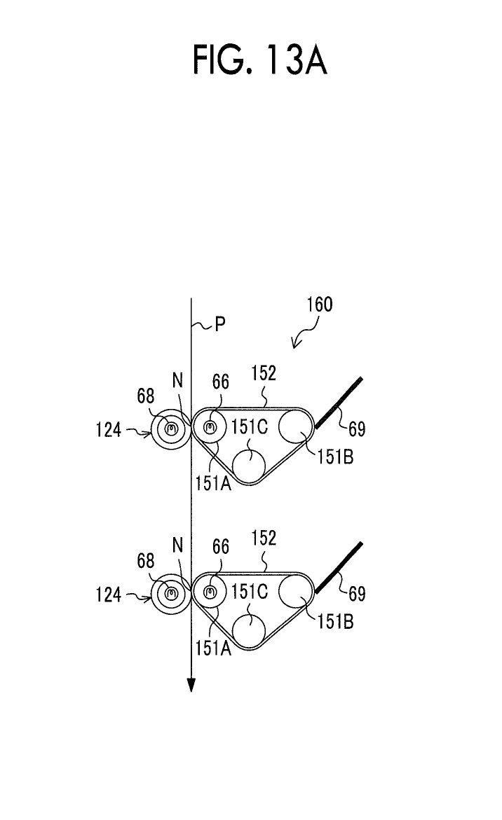

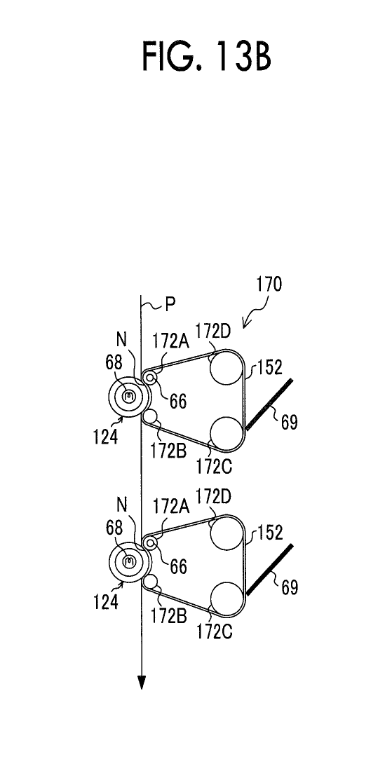

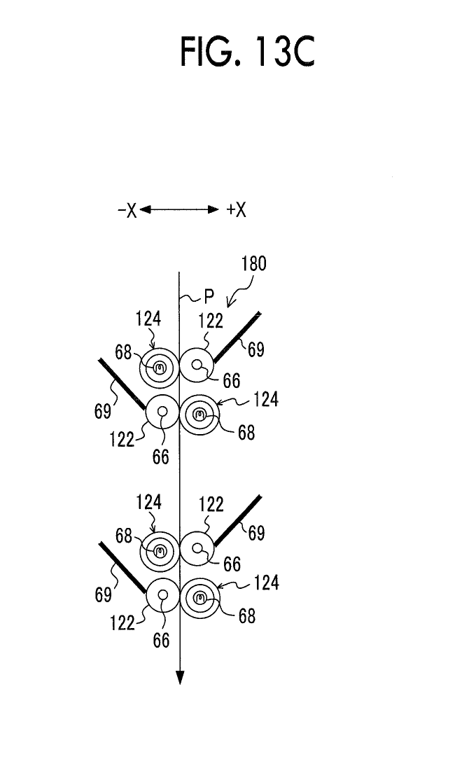

FIG. 13A shows a carrier liquid removing portion 160 according to the third modification example. The carrier liquid removing portion 160 is provided instead of the carrier liquid removing portion 150 in the fixing device 130 (refer to FIG. 12) of the second modification example. Moreover, in the carrier liquid removing portion 160, the belt 152 (refer to FIG. 12) of the carrier liquid removing portion 150 is wound around three rolls 151A, 151B, and 151C and thus, is formed in a triangle. In this way, the movement direction of the belt 152 in the contact portion N may be changed by adding the roll 151C. In addition, a temperature sensor that detects a temperature of the belt 152 is not shown.

### Fourth Modification Example

FIG. 13B shows a carrier liquid removing portion 170 according to the fourth modification example. The carrier liquid removing portion 170 is provided instead of the carrier liquid removing portion 150 in the fixing device 130 (refer to FIG. 12) of the second modification example. Moreover, in the carrier liquid removing portion 170, the belt 152 (refer to FIG. 12) of the carrier liquid removing portion 150 is wound around four rolls 172A, 172B, 172C, and 172D, and thus, is formed in a trapezoid shape.

The rolls 172A and 172B interpose the sheet P along with the pressure roll 124, and thus, the contact portion N is formed. In addition, the roll 172A is placed at the upstream side of the roll 172B in the transport direction of the sheet P, and the halogen heater 66 is provided inside the roll 172A. In this way, by forming the contact portion N using the rolls 172A and 172B, a contact width between the sheet P and the toner image TA at the contact portion N is widened. Accordingly, even when the sheet is transported at a high speed, the carrier liquid CA is removed. In addition, the temperature sensor that detects the temperature of the belt 152 is not shown.

### Fifth Modification Example

FIG. 13C shows a carrier liquid removing portion 180 according to the fifth modification example. In the carrier liquid removing portion 180, in the fixing device 100 (refer to FIG. 10) of the first modification example, the metal roll 122 and the pressure roll 124 are placed (are alternately placed) to replace each other in the +X side and the −x side of the sheet P for each set in the transport direction of the sheet P. In this configuration, even when the toner image TA (refer to FIG. 2) is formed on both surfaces of the sheet P, the carrier liquid CA is removed.

Moreover, the present invention is not limited to the exemplary embodiment and the modification examples described above.

The upstream side heating portion is not limited to a non-contact heating system that uses the carbon heater 53, and may be a contact heating system that uses a roll or the like. In addition, in the preprocessing unit, the upstream side heating portion may not be provided.

The temperatures of the plural metal rolls 62 and the plural belts 152 are not limited to the same temperature, and may be different from one another at each step. As an example, the temperatures may be within a range of ±10° C. with respect to the set temperatures. In addition, the material of the metal roll 62 is not limited to aluminum, and the metal roll 62 may be made of SUS or other metals. Moreover, the metal roll 62 may be driven by a motor or may be driven following the rotation of the pressure roll. The pressure member is not limited to the pressure roll 64, and a belt material may be used. Moreover, the pressure member is not limited to a rotating member, and may be a fixed member.

In each carrier liquid removing portion, the recovery blade 69 may not be provided. Moreover, each carrier liquid removing portion may include one set of the metal roll 62 and the pressure roll 64.

The fixing unit is not limited to the roll system that uses the fixing roll 72, and may be a belt system. In addition, if the set value of the gloss of the toner image TB can be obtained, the fixing unit is not limited to a contact heating system, and may be a non-contact heating system.

The toner T is not limited to a polyester resin and may include other resins. Moreover, the carrier liquid CA is not limited to dimethylsilicone oil and may use other oils.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device, comprising:
a fixing unit that fixes a toner image developed by a developer including toner and a carrier liquid to a recording medium; and
a preprocessing unit that includes a metallic rotating body that is placed on the toner image side of the recording medium and rotates, a pressure member that includes an elastic layer and pressurizes the recording medium along with the rotating body, and a heating unit that heats the rotating body,
the preprocessing unit being placed at the upstream side of the fixing unit in a transport direction of the recording medium, and performing preprocessing by which a portion of the carrier liquid is removed from the recording medium.

2. The fixing device according to claim 1,
wherein the preprocessing unit includes a plurality of the rotating bodies, the pressure members, and the heating units that are arranged in the transport direction.

3. The fixing device according to claim 1, further comprising:
a recovery member that recovers the carrier liquid from the rotating body.

4. The fixing device according to claim 2, further comprising:
a recovery member that recovers the carrier liquid from the rotating body.

5. The fixing device according to claim 1,
wherein the carrier liquid includes dimethylsilicone oil.

6. The fixing device according to claim 2,
wherein the carrier liquid includes dimethylsilicone oil.

7. The fixing device according to claim 3,
wherein the carrier liquid includes dimethylsilicone oil.

8. The fixing device according to claim 4,
wherein the carrier liquid includes dimethylsilicone oil.

9. The fixing device according to claim 5,
wherein the toner includes a polyester resin.

10. The fixing device according to claim 6,
wherein the toner includes a polyester resin.

11. The fixing device according to claim 7,
wherein the toner includes a polyester resin.

12. The fixing device according to claim 8,
wherein the toner includes a polyester resin.

13. The fixing device according to claim 1,
wherein the preprocessing unit includes an upstream side heating portion that heats the recording medium in a non-contact state at the upstream side of the rotating body in the transport direction.

14. The fixing device according to claim 2,
wherein the preprocessing unit includes an upstream side heating portion that heats the recording medium in a non-contact state at the upstream side of the rotating body in the transport direction.

15. The fixing device according to claim 3,
wherein the preprocessing unit includes an upstream side heating portion that heats the recording medium in a non-contact state at the upstream side of the rotating body in the transport direction.

16. The fixing device according to claim 4,
wherein the preprocessing unit includes an upstream side heating portion that heats the recording medium in a non-contact state at the upstream side of the rotating body in the transport direction.

17. The fixing device according to claim 5,
wherein the preprocessing unit includes an upstream side heating portion that heats the recording medium in a non-contact state at the upstream side of the rotating body in the transport direction.

18. The fixing device according to claim 6,
wherein the preprocessing unit includes an upstream side heating portion that heats the recording medium in a non-contact state at the upstream side of the rotating body in the transport direction.

19. The fixing device according to claim 1,
wherein the fixing unit includes a fixing rotating body including a release layer contacting the toner image on an outer circumferential surface of the elastic layer.

20. An image forming apparatus, comprising:
an image holding member that holds an electrostatic latent image;
a developing device that develops the electrostatic latent image formed on the image holding member by a developer including toner and a carrier liquid;
a transfer device that transfers a toner image developed by the developing device to a recording medium; and
the fixing device according to claim 1 that fixes the toner image transferred to the recording medium by the transfer device to the recording medium.
